(19) United States
(12) Patent Application Publication
(10) Pub. No.: US 2009/0313641 A1
(43) Pub. Date: Dec. 17, 2009

(54) APPLICATION MANAGEMENT METHODS AND SYSTEMS

(75) Inventors: Chi-Yang CHOU, Kao-hsiung (TW); Pei-Yen CHOU, Hsin-chu (TW); Yeu-Chung LIN, Chang-hua (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CONDEL INTERNATIONAL TECHNOLOGIES INC., George Town (KY)

(21) Appl. No.: 12/137,574

(22) Filed: Jun. 12, 2008

(51) Int. Cl. G06F 9/46

(52) U.S. Cl. 719/320

(57) ABSTRACT

Application management methods and systems are provided. The OS (Operating System) information of a specific platform of a device is first obtained. A specific application among a plurality of applications is selected according to the OS information, wherein the applications are respectively coded for a plurality of platforms. Then, the selected application is executed on the device.

### BACKGROUND OF THE INVENTION

1. Field of the Invention

The disclosure relates generally to application management methods and systems, and, more particularly to application management methods and systems that interoperate applications among different operation system platforms.

2. Description of the Related Art

With electronic devices, such as computers or portable devices, being popular, digital content has become a major data recording type for the devices due to increased convenience of digital content. Moreover, content providers have been devoted to develop related applications for digital content. Since it is easy to copy and broadcast digital content, the authentication management of digital content has become one of the major developmental areas in the content management art.

For authentication management of digital content, applications for DRM (Digital Rights Management) have been developed. Generally, the devices may have different OS (Operation System) platforms, such as a Symbian, Window Mobile, Linux, Android, and other platforms, and the applications may be device-dependent or OS-dependent since the applications must comply with the OS structures of the respective devices, and may need specific functions called from the respective OSs.

In practice, different applications must be developed for respective devices since the OS platforms of respective devices are not necessarily compatible. For example, a DRM application can be coded in a program language, such as C++. When the DRM application is developed for a Symbian platform, the DRM application is then compiled using a compiler “Makesis” of the Symbian platform to obtain an execution file which can be operated on the platform, such as a .sis file. The “Makesis” compiled execution file can be only used in the Symbian platform, but not necessarily applicable for other platforms.

Conventionally, content providers must have agreements with different device platform providers, so that different packages comprising the same content and different DRM applications in various platforms may be prepared. For content providers, the method and system is troublesome, and related production costs are increased.

### BRIEF SUMMARY OF THE INVENTION

Application management methods and systems are provided.

In an embodiment of an application management method, the OS (Operating System) information of a specific platform of a device is first obtained. A specific application among a plurality of applications is selected according to the OS information, wherein the applications are respectively coded for a plurality of platforms. Then, the selected application is executed on the device.

An embodiment of an application management system comprises a device, a plurality of applications, and a management module. The device has a specific platform. The applications are respectively coded for a plurality of platforms. The management module obtains OS (Operating System) information of the specific platform of the device, and selects a specific application among the applications according to the OS information. The management module drives the selected application to be executed on the device.

Application management methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an application management system according to the invention; and

FIG. 2 is a flowchart of an embodiment of an application management method according to the invention.

### DETAILED DESCRIPTION OF THE INVENTION

Application management methods and systems are provided.

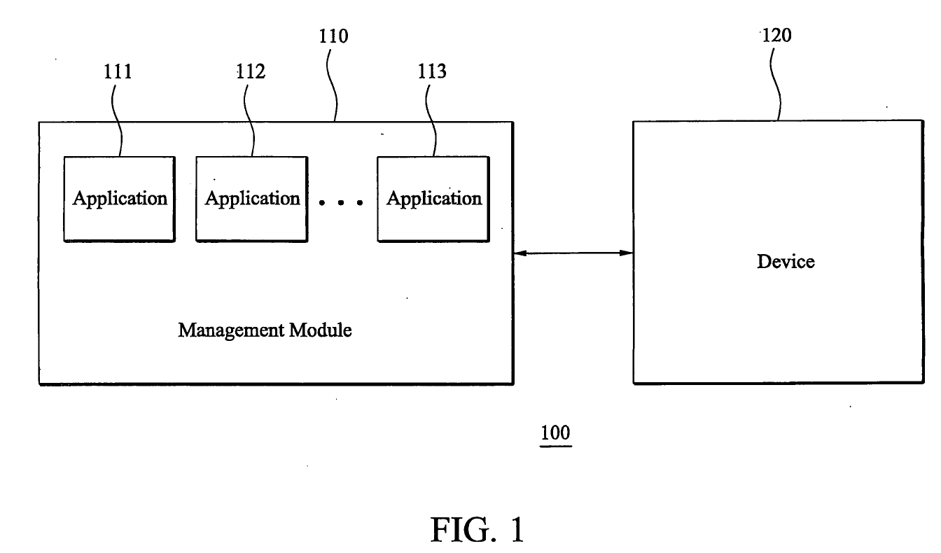

FIG. 1 is a schematic diagram illustrating an embodiment of an application management system according to the invention.

The application management system 100 comprises a management module 100 and a device 120. The device 120 may be a processor-based electronic device, such as a computer, or a portable device such as PDAs, global positioning system devices or mobile phones. The management module 110 may be coded using a first program language, such as JAVA, and stored in a storage medium, such as an USB disc or a flash card. The first program language is supported by different platforms, such as a Symbian, Window Mobile, Linux, Android, and other platforms. The management module 110 comprises a plurality of applications (111, 112, and 113). In some embodiments, the respective applications may be coded for respective platforms using a second program language, such as C++, and compiled using the respective compilers of the platforms. The management module 110 automatically detects the OS information of the platform of the device 120, and selects one of the applications to be executed on the device 120 according to the detected OS information. It is understood that, in some embodiments, the management module 110 may provide an interface comprising a plurality of predefined platforms. One of the predefined platforms can be selected, such that the OS information of the platform of the device 120 can be obtained. It is noted that, in some embodiments, content may exist in the storage medium containing the management module 110. In these embodiments, the respective applications may be DRM applications developed for the respective platforms.

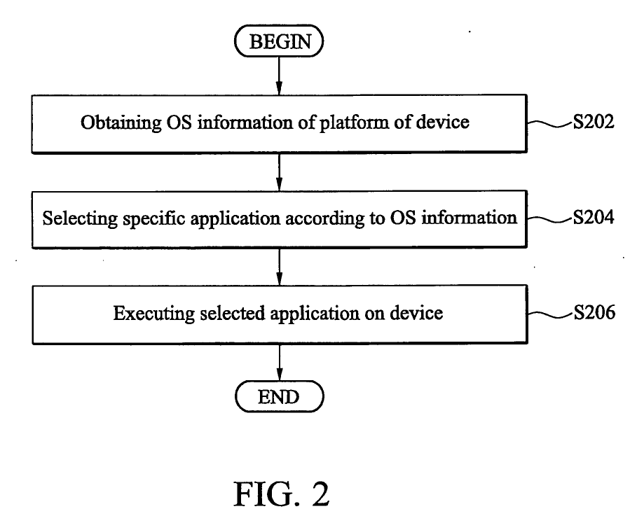

FIG. 2 is a flowchart of an embodiment of an application management method according to the invention.

In step S202, the OS information of a platform of a device is obtained. It is understood that, in some embodiments, the OS information can be obtained by automatically detecting the platform of the device by a program coded using a specific program language supported by the respective platforms. In some embodiments, an interface can be provided for selecting the platform of the device, thus obtaining the OS information. In step S204, a specific application among a plurality of applications is selected according to the OS information. It is noted that, the applications are respectively developed for the respective platforms. In some embodiments, the respective applications may be DRM applications developed for the respective platforms. In step S206, the selected application is executed on the device for related management procedures, such as DRM on the device.

Therefore, the methods and systems of the application can integrate applications developed for respective platforms, thus to interoperate applications among different platforms. For application, content providers can prepare only one package comprising content and the management module for all platforms, thereby saving related production costs.

Application management methods and systems, or certain aspects or portions thereof, may take the form of a program code (i.e., executable instructions) embodied in tangible media, such as USB disk, flash card, etc., wherein, when the program code is loaded into and executed by a machine, such as a mobile phone, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a mobile phone, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An application management method, comprising:
obtaining OS (Operating System) information of a specific platform of a device;
selecting a specific application among a plurality of applications according to the OS information, wherein the applications are respectively coded for a plurality of platforms; and
executing the selected application on the device.

2. The method of claim 1, further comprising providing an interface for selecting the specific platform to obtain the OS information.

3. The method of claim 1, further comprising automatically detecting the specific platform to obtain the OS information.

4. The method of claim 1, wherein the step of automatically detecting the specific platform to obtain the OS information is performed by a management module coded using a first program language, wherein the first program language is supported by the platforms.

5. The method of claim 4, wherein the applications are respectively coded using a second program language.

6. The method of claim 1, wherein the selected application performs digital rights management on the device.

7. An application management system, comprising:
a device having a specific OS (Operating System) platform;
a plurality of applications, wherein the applications are respectively coded for a plurality of platforms; and
a management module obtaining the OS (Operating System) information of the specific platform of the device, selecting a specific application among the applications according to the OS information, and executing the selected application on the device.

8. The system of claim 7, further comprising an interface for selecting the specific platform to obtain the OS information.

9. The system of claim 7, wherein the management module further automatically detects the specific platform to obtain the OS information.

10. The system of claim 7, wherein the management module is coded using a first program language, wherein the first program language is supported by the platforms.

11. The system of claim 10, wherein the applications are respectively coded using a second program language.

12. The system of claim 7, wherein the selected application performs digital rights management on the device.

13. A machine-readable storage medium comprising a computer program, which, when executed, causes a device to perform an application management method, and the method comprising:
obtaining OS (Operating System) information of a specific platform of the device;
selecting a specific application among a plurality of applications according to the OS information, wherein the applications are respectively coded for a plurality of platforms; and
executing the selected application on the device.
